(19) United States
(12) Patent Application Publication
(10) Pub. No.: US 2025/0094718 A1
(43) Pub. Date: Mar. 20, 2025

(54) DOMAIN-SPECIFIC NAMED ENTITY EXTRACTION AND MAPPING

(71) Applicant: Microsoft Technology Licensing, LLC, Redmond, WA (US)

(72) Inventors: Ji Yan, San Jose, CA (US); Rui Kou, San Jose, CA (US); Di Zhou, Newark, CA (US); Lu Sun, San Jose, CA (US)

(21) Appl. No.: 18/470,921

(22) Filed: Sep. 20, 2023

(51) Int. Cl. G06F 40/295; G06F 40/30

(52) U.S. Cl. CPC G06F 40/295; G06F 40/30

(57) ABSTRACT

A text from a predetermined domain is taken and converted to canonical named entities based on an established taxonomy. Using a shared machine learning encoder model, contextual embeddings for these named entities are produced. These embeddings are then fed into a domain-specific scoring model related to the text's domain. This model ranks the embeddings based on relevance. The derived relevance scores, along with the entities, are sent to another system for further tasks. For instance, a recommendation system might use these scores to suggest relevant named entities.

### BACKGROUND

Name entity extraction, sometimes called named entity recognition, is an information extraction task that seeks to locate and classify named entities mentioned in text into pre-defined categories such as person names, organizations, locations, medical codes, time expressions, quantities, monetary values, percentages, etc. Sometimes, the same entity can appear in multiple different textual domains. For example, skills such as computer programming, analytical reasoning, emotional intelligence, financial planning, foreign language proficiency, photography, electrical work, etc. can appear in resumes, learning course descriptions, and job descriptions.

### BRIEF DESCRIPTION OF THE DRAWINGS

The following detailed description of certain embodiments of the invention may be understood by reference to the following figures:

FIG. 1 illustrates an example of a domain-specific named entity extraction and mapping system.

FIG. 2 depicts an example of connected named entities with hierarchical relationships that might exist within a named entity taxonomy.

FIG. 3 illustrates an example of polyhierarchy represented as child-parent relationships that might exist within a named entity taxonomy.

FIG. 4 illustrates an example polyhierarchy represented as parent-child relationships that might exist within a named entity taxonomy.

FIG. 5 illustrates an example of different text sections of a text in a text domain.

FIG. 6 illustrates a token-based matching approach for tagging named entities in a text.

FIG. 7 illustrates a semantic-based matching approach for tagging named entities in a text.

FIG. 8 illustrates an example of a shared contextual encoder.

FIG. 9 illustrates an example of domain-specific scorer models.

FIG. 10 illustrates an example use case of domain-specific named entity extraction and mapping.

FIG. 11 illustrates an example use case of domain-specific named entity extraction and mapping.

FIG. 12 is a flowchart of an example method for domain-specific named entity extraction and mapping.

FIG. 13 illustrates an example of a programmable electronic device that processes and manipulates data to perform tasks and calculations disclosed herein for domain-specific named entity extraction and mapping.

### DETAILED DESCRIPTION

Systems, methods, and non-transitory computer-readable media (generally, “techniques”) are disclosed for domain-specific named entity extraction and mapping. The techniques improve the tasks of named entity extraction and mapping using machine learning where named entities appear in different text domains.

Extracting and mapping named entities from varying text domains using machine learning presents several technical challenges. One challenge is the difficulty of obtaining high-quality training data for train machine learning models to accurately perform named entity extraction and mapping that covers varying terminology, specificities, contextual ambiguities, granularities, and other variances across the different text domains. For example, a resume might mention “Excel” while another might specify “pivot tables in Excel” or “Excel data visualization.” A learning course description might describe a skill in a theoretical or academic manner, e.g., “Fundamentals of spreadsheet data manipulation.” A job description might use broader terms or industry jargon such as by stating “proficiency in data analysis tools” rather than specifying Excel. For example, skills might be mentioned in different contexts across domains. For instance, the term “Java” in a resume might refer to the programming language, but in a course description for coffee brewing, it refers to a type of coffee bean. For example, a resume may list skills with varying levels of detail, from broad competencies like “communication” to specific tools like “MATLAB.” A learning course description might discuss skills in the context of learning outcomes or objectives. The granularity might be more related to understanding concepts than applying tools. A job description can be both specific (“Must know Excel”) and generic (“Good problem-solving skills”). Named entities can be implied through explicit mentions. For example, a course description might not say “Excel” explicitly but might imply it by mentioning “spreadsheet formulas.” Text domains can have different structures and formats. For example, resumes may have skills scattered throughout sections like “like “Experience,” “Skills,” or embedded within job roles. A learning course description is often written in prose, with skills interwoven in paragraphs discussing the course's goals. Some job descriptions may have clear “Required Skills” sections, while others embed skills within role and responsibilities. Domain-specific jargon and abbreviations may be used. For example, “NLP” could be “Natural Language Processing” in a tech-focused resume, but “Neuro-Linguistic Programming” in a personal development course description. Distinguishing between soft skills (e.g., “teamwork,” “leadership”) and hard or technical skills (e.g., “Python programming,” “data analysis”) can be tricky, especially when the language gets ambiguous. Synonyms and variations may be used. For example, a skill can be described in various ways. For instance, “database design” might also be written as “DB design” or “designing relational databases.”

It is desirable to be able to accurately extract and map named entities across different text domains with some or all the above variances. And it is desirable to do this where it is possible that the machine learning training data used to train the extraction and mapping machine learning model or models lacks examples of certain terminologies, specificities, contextual ambiguities, granularities, or other variances.

The disclosed techniques address this technical challenge using domain-specific named entity extraction and mapping. A text that belongs to a pre-defined text domain of a set of pre-defined text domains is received. The text is mapped and expanded to one or more canonical named entities in a named entity taxonomy. A shared machine learning encoder model, shared across all text domains, is employed to generate a contextual embedding for each of the canonical named entities. The generated contextual embeddings are input into a domain-specific machine learning scoring model associated with the pre-defined text domain to which the text belongs. This scoring model scores each of the contextual embeddings according to relevance. The generated relevance scores, alongside the scored named entities, are then passed to another computer system for additional processing. As an example, this receiving system could be a named entity recommendation system that suggests one or more scored named entities based on their respective relevance scores.

A named entity recommendation system is a specific type of computer system that is configured (programmed) to make recommendations of named entities. By providing the relevance scores to the recommendation system, the recommendation system is improved in its ability to make recommendations. The recommendation system is improved because it can make accurate recommendations based on the relevance scores provided even where the machine learning training data used to train the extraction and mapping machine learning model or models lacks examples of certain terminologies, specificities, contextual ambiguities, granularities, or other variances.

For instance, consider a resume that falls within a ‘resume’ domain. A domain-specific named entity extraction and mapping system may map the resume to one or more canonical skills in a skill taxonomy. As one example, if the resume contains the text “experience with design of iOS applications,” the system may map the resume to the canonical skill “Mobile Development.” The system employs a shared machine learning encoder model to generate a contextual embedding for each of the canonical skills to which the text is mapped. These contextual embeddings are subsequently input by the system into a domain-specific machine learning scoring model for the ‘resume’ domain. This model processes the input contextual embeddings to assign relevance scores to each canonical skill. The computed relevance scores, along with the scored skills, may then be relayed to a skill recommendation system or other system for further processing.

Use of both the shared machine learning encoder model and the domain-specific machine learning scoring models provides advantages that enhance the performance and adaptability of the system.

The shared machine learning encoder model is trained on data across all the pre-defined text domains. This allows it to learn general representations of named entities and contexts. This generalized knowledge results in better performance when applied to domain-specific data later.

The shared encoder promotes efficiency in terms of both computation resources and model management because the foundational processing and extraction mechanisms are common across all the pre-defined text domains.

The domain-specific scoring models can learn the nuances of each text domain. As a result, the combination of the shared machine learning encoder model and the domain-specific machine learning scoring models is adaptable to different text domains while still leveraging a common underlying representation. As new text domains arise, a new domain-specific scoring model can be developed without having to redesign the shared machine learning encoder model. This modular feature allows more streamlined expansion of the system to new text domains.

By splitting the system into a shared stage and a domain-specific stage, overfitting is reduced. The shared encoder captures broad patterns, while the domain-specific scoring models focus on the domain-specific nuances without being overly tailored to the training data.

The domain-specific scoring models can be finely calibrated to accurately score and rank named entities in their respective text domains resulting in improved precision or recall.

### Example Domain-Specific Named Entity Extraction and Mapping System

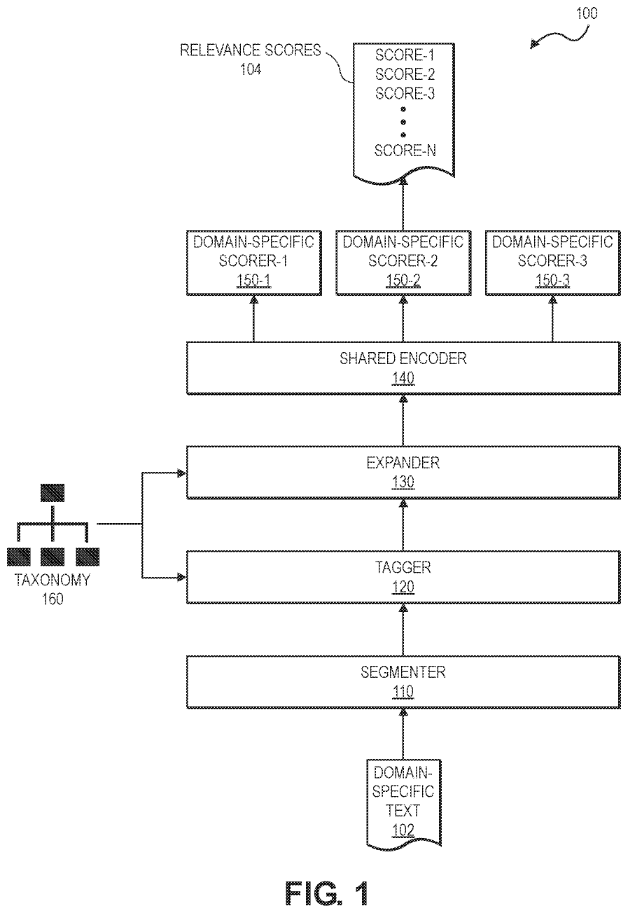

Turning now to FIG. 1, it illustrates an example of a domain-specific named entity extraction and mapping system. Domain-specific named entity extraction and mapping system 100 includes segmenter 110, tagger 120, expander 130, shared machine learning encoder model 140, and domain-specific machine learning scorer models 150-1, 150-2, and 150-3. Input to system 100 includes domain-specific text and output of system 100 includes relevance scores 104. System 100 also includes named entity taxonomy 160.

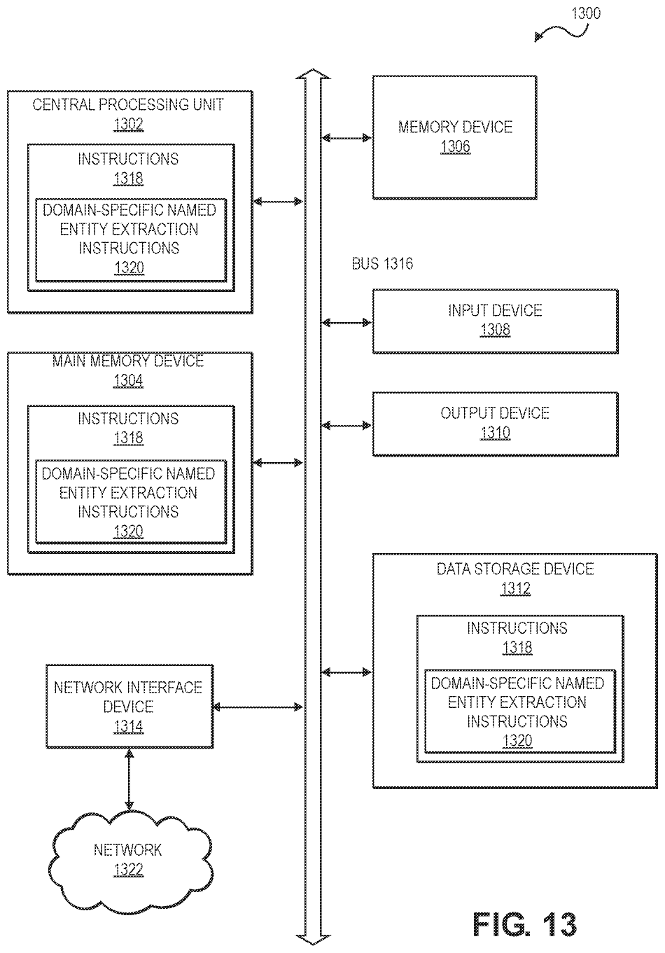

System 100 is implemented by one or more programmable electronic devices. An example of a programmable electronic device is described below with respect to FIG. 13. In some examples, system 100 is implemented as a component of a cloud application service. For example, the programmable electronic devices that implement system 100 may be servers of the cloud application service. However, system 100 may be distributed across a wide area network (e.g., the internet). For example, some of the programable electronic devices that implement system 100 may be at the edge of a wide area network (e.g., the internet) while other programmable electronic device(s) that implement system 100 may be server(s) of a cloud application service. While system 100 may be implemented by multiple programmable electronic devices, system 100 may be implemented by a single programmable electronic device. For example, system 100 may be implemented by a single service of a cloud application service or by a single personal computing device.

There are many use cases for system 100. Example use cases described herein pertain to domain-specific skill extraction and mapping such as, for example, extracting and mapping skills from resumes, learning course descriptions, and job descriptions. However, use of system 100 is not limited to the example use cases. The example use cases are described solely to provide clear examples and system 100 may be used for other use cases including use cases that do not involve domain-specific skill extraction and mapping. Generally, system 100 may be used for any named entity extraction and mapping use case where the named entities are extracted and mapped from different text domains.

In one example use case, system 100 is used by a cloud application service to extract and map career relevant skills from text available to the cloud application service. The extracted and mapped skills are used by the cloud application to recommend relevant job opportunities to users of the cloud application service or to recommend candidates to job recruiter users of the cloud application service. In another example use case, skills extracted and mapped from text by system 100 are used by a cloud application service for skill proficiency estimation to infer an expertise of a user of the cloud application service. In another example use case, system 100 is used by a cloud application service to extract and map job important skills. The extracted skills are used by cloud application service to determine which skills are most important to job openings.

At a high-level, system 100 operates as follows. Domain-specific text 102 is input to segmenter 110. For example, domain-specific text 102 may be a resume, a learning course description, or a job description. Segmenter 110 segments text 102 into one or more logical text sections that are particular to the domain of text 102. For example, segmenter 110 may segment a resume into a “skills” text section and a “past experiences” text section. Segmenter 110 outputs each text section segmented from text 102.

Each text section output by segmenter 110 for text 102 is input by system 100 to tagger 120. For each input text section, tagger 120 maps the text section to one or more “tagged” named entities in named entity taxonomy 160. In some examples, tagger 120 uses one or both of a token-based matching approach or a semantic-based matching approach to map a text section to the one or more tagged named entities. Both mapping approaches are described in greater detail below. Tagger 120 outputs the one or more tagged named entities to which text 102 is mapped.

The one or more tagged named entities output by tagger 120 for text 102 are input by system 100 to expander 130. For each input tagged named entity, expander 130 may identify one or more “expanded” named entities in named entity taxonomy 160. For example, an expanded named entity could be a parent named entity, a child named entity, or a sibling named entity of a tagged named entity in a hierarchy of taxonomy 160. Expander 130 outputs the one or more expanded named entities for the one or more tagged named entities output by tagger 120.

A set of canonical named entities for text 102 encompassing the one or more tagged named entities output by tagger 120 for text 102 and the one or more expanded named entities output by expander 130 for text 102 are input by system 100 to shared encoder 140. Shared encoder 140 generates a contextual embedding for each canonical named entity. A contextual embedding for a canonical named entity can represent either or both the canonical named entity's interpretation in the context of text 102 and the canonical named entity's interpretation in relation to other named entities. The operation of shared encoder 140 is described in greater detail below. Shared encoder 140 outputs a contextual embedding for each input canonical named entity for text 102.

The contextual embeddings output by shared encoder 140 for text 102 are input the domain-specific scorer that is specific to the text domain to which text 102 belongs. For example, domain-specific scorer-1 150-1 may be for resumes, domain-specific scorer-2 150-2 for learning course descriptions, and domain-specific scorer-3 150-3 may be for job descriptions. If text 102 is a resume, then the contextual embeddings would be input by system 100 into domain-specific scorer-1 150-1. If text 102 is a learning course description, then the contextual embeddings would be input by system 100 into domain-specific scorer-2 150-1. If text 102 is a job description, then the contextual embeddings would be input by system 100 into domain-specific scorer-3 150-3. In the example of FIG. 1, there are three text domains and three corresponding domain-specific scorers 150-1, 150-2, and 150-3. However, this is just one possible arrangement. The number of domain-specific scorers can vary depending on the number of text domains of the implementation at hand. For example, there can be as few as two text domains and two corresponding domain-specific scorers or more than three text domains and more than three corresponding domain-specific scorers.

The domain-specific scorer scores each contextual embedding for relevance. The output of the domain-specific scorer is relevance scores 104. Relevance scores 104 encompasses a relevance score for each input contextual embedding and represents the relevance of the corresponding canonical named entity to text 102. Relevance scores 104 along with the corresponding canonical named entities scores can be provided to another system for further processing.

For example, the other system receiving relevance scores 104 may associate the top-scoring canonical named entities for text 102 with a user or other entity associated with text 102. For example, if text 102 is a resume of a member of an online professional network and the canonical named entities determined for text 102 are skills extracted from text 102 by system 100, then the network may associate one or more top-scoring skills with the member in a database. Additionally, or alternatively, the network may recommend one or more top-scoring skills to the member as ones the member should consider adding to their online profile. As another example, if text 102 is a job description and the canonical named entities determined for text 102 are skills extracted from text 102 by system 100, then the network may use one or more top-scoring skills match the job opening with candidate members determined to have those skills.

### Named Entity Taxonomy

System 100 encompasses named entity taxonomy 160. Taxonomy 160 is where named entities in a particular named entity category are organized and categorized based on their hierarchical relationships to each other. For example, taxonomy 160 can be where skills are organized and categorized based on their relationships to each other.

Taxonomy 160 can be implemented in a variety of different ways and no particular way is required. For example, taxonomy 160 can be implemented in any one the following ways or as a combination of two or more of the following ways: using nested data structures like arrays, lists, or dictionaries to represent the hierarchical relationships between named entities; using a relational database storing hierarchical data where each row in a database table represents an item, and columns include identifiers, parent IDs, and other relevant identifiers or where parent-child relationships are maintained through the user of foreign keys; using extensible Markup Language (XML) or JavaScript Object Notation (JSON) documents, where elements or objects are nested within one another to create the hierarchy or where XML tags or JSON keys represent different levels of the hierarchy; using a directed acyclic graph (DAG) structure where each node of the graph represents a named entity and edges represent relationships between named entities; using custom data structure specifically designed for hierarchical data, such as trees or trie structures that maintain parent-child relationships and facilitate efficient traversal; using a graph database such as, for example, Neo4j or the like, that is designed to handle complex relationships including modeling and querying hierarchical taxonomies efficiently; or using any other structure suitable for storing and access hierarchical data.

Taxonomy 160 may store more than just named entities. Taxonomy 160 may also store attributes of named entities. For example, where taxonomy 160 stores skills, taxonomy 160 might include details about each skill such as skill IDs, skill aliases, skill types, etc. For example, an entry (e.g., node) for a “machine learning” skill in taxonomy 160 may include any or all of the following details: a number assigned to the skill that is the skill's ID in taxonomy 160, one or more aliases for the skill such as “ML” or language translations, a skill type such as “soft skill” or “hard skill,” a description of the skill (e.g., “machine learning is a subset of artificial intelligence (AI) that involves the development of algorithms and models that enable computers to learn from and make predictions or decisions based on data.”), etc.

Taxonomy 160 may represent each named entity as a “node.” Nodes may be linked together to form a hierarchical named entity network through “edges.” An edge may reflect how two named entities in taxonomy 160 relate to each other. An edge may be directed when the semantics of the directed edge is from the “parent” node to the “child” node.

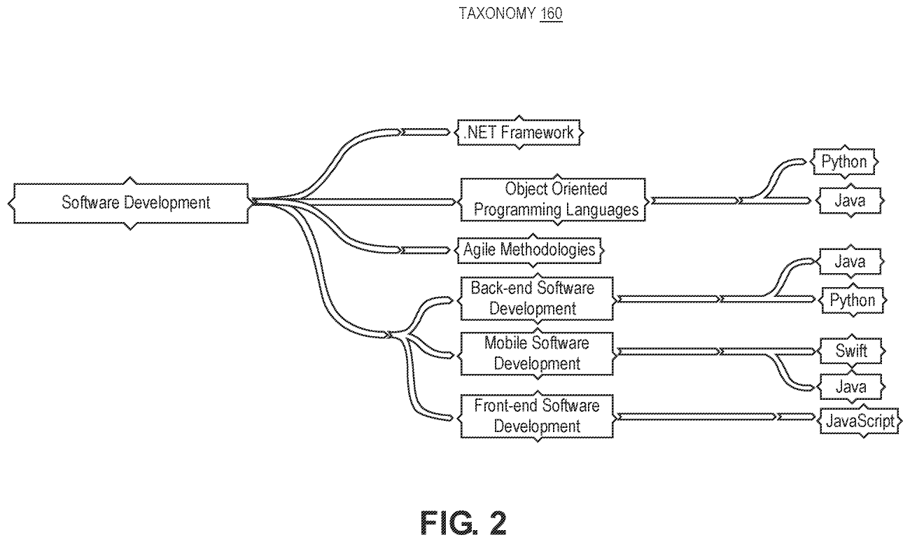

For example, FIG. 2 depicts an example of connected named entities with hierarchical relationships that might be present in taxonomy 160. The “Software Development” skill is a parent of the “Object Oriented Programming Languages” skill which has the children “Python” and “Java.” As an example, tagger 120 may map text 102 to a named entity of the connected skills. For example, if text 102 states “experience with design of Python applications,” then tagger 120 might map text 102 to the “Python” skill of the connected skills using the token-based matching approach described in greater detail below.

Named entities in taxonomy 160 can form polyhierarchical relationships, meaning one named entity can be mapped in taxonomy 160 to multiple parent and child named entities by mutual inclusion. For example, an “Offshore Construction” skill could be mapped to both a “Construction” skill and an “Oil and Gas” skill. An ambiguous named entity such as, for example, a “Networking” skill could be mapped to both a “Computer Networking” skill and a “Professional Networking” skill. However, in some implementations, such ambiguous mappings are not made in taxonomy 160 to provide a more well-defined structure of the named entities in taxonomy 160 and to facilitate computer-based reasoning about the named entities in taxonomy 160.

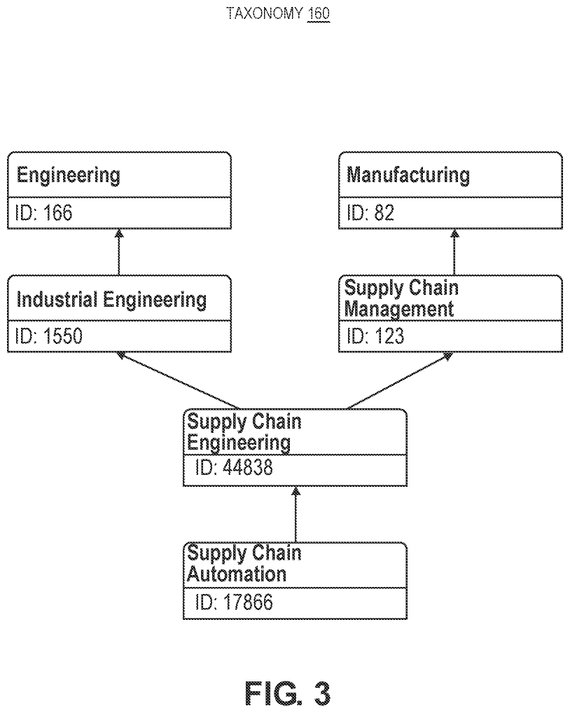

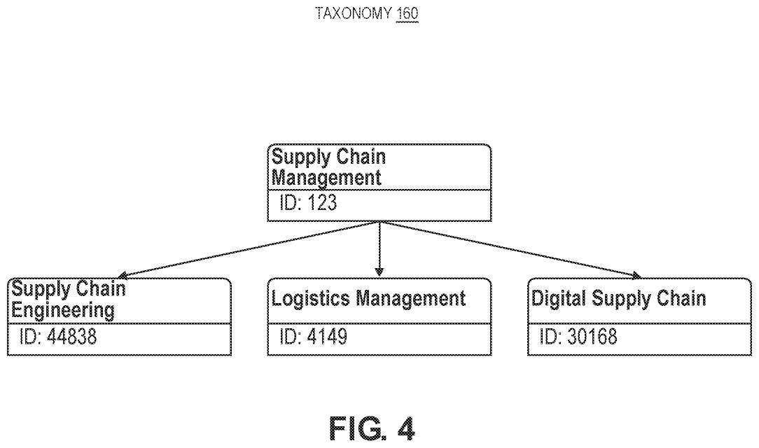

FIG. 3 illustrates an example of polyhierarchy represented as child-parent relationships that might exist in taxonomy 160. FIG. 4 illustrates an example polyhierarchy represented as parent-child relationships that might exist in taxonomy 160. Referring to FIG. 3, in this example, the skill “Supply Chain Automation” is a parent skill of the “Supply Chain Engineering” skill which is linked to the “Engineering” skill and the “Manufacturing” skill. The polyhierarchy represents, among other things, that a person with the skill “Supply Chain Automation” knows something about each of the ancestor skills in the lineage. As an example, expander 130 may expand a tagged named entity such as “Supply Chain Engineering” output by tagger 120 for text 102 to the ancestor skills in the lineage up to the top nodes including “Industrial Engineering,” “Supply Chain Management,” “Engineering”, and “Manufacturing.” In some examples, there is a limit to the number of hierarchical levels in taxonomy 160 that expander 130 will expand a tagged named entity into. For example, if the limit is 1 level and tagged named entity is “Supply Chain Engineering”, then expander 130 may expand that tagged named entity into just its parents “Industrial Engineering” and “Supply Chain Management.”

The named entities in taxonomy 160 may be manually curated, machine learning curated, or a combination of manual and machine learning curation. For example, a machine learning model may be trained on manually curated training data to predict the relationship between two given named entities A and B (e.g., “A is a parent of B,” “A is a child of B”, or “no relation”). Taxonomy 160 can then be constructed to represent the relationships determined by the model with edges between nodes representing the named entities that have the determined relationships.

### Segmenter

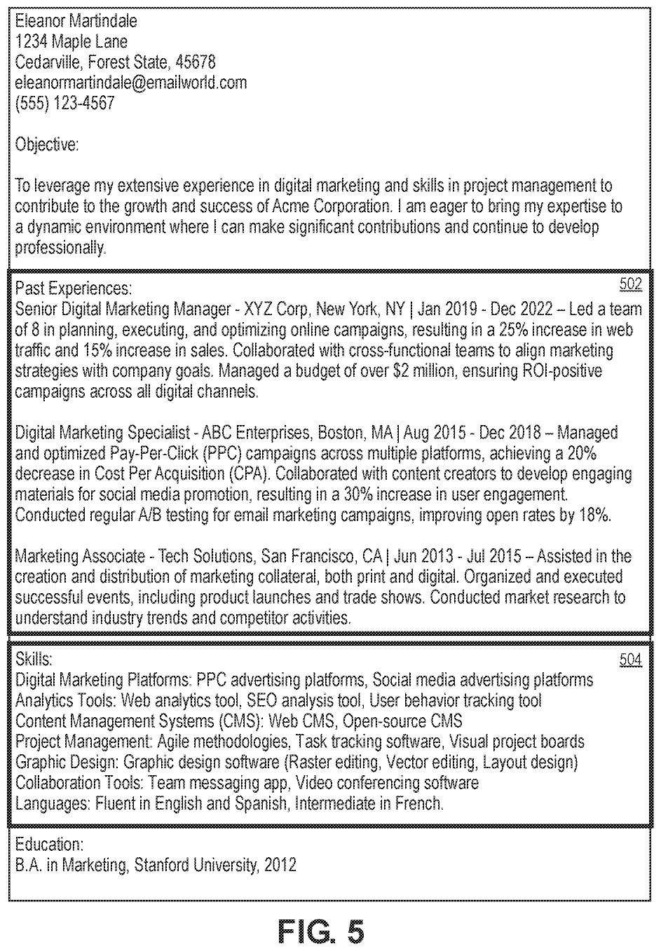

Segmenter 110 may segment domain-specific text 102 into text sections for further processing by system 100. Each text section can then be processed by other components of system 100 separately as opposed to processing text 102 as a whole. The segmenting performed by segmenter 110 on text 102 aims to increase contextual understanding by system 100 and to increase the accuracy of the named entity extraction and mapping task performed by system 100. For example, a job posting may have sections for “company description,” “responsibilities,” “benefits,” and “qualifications.” If system 100 operates to extract and map relevant skills from text 102, then such skills are more likely to found in the “responsibilities” and “qualifications” sections compared to the “benefits” and “company description” sections. FIG. 5 provides another example where a resume has “past experiences” section 502 and “skills” section 504. If system 100 operates to extract and map relevant skills from text 102, then such skills are more likely to be found in these sections 502 and 504 compared to other sections of the resume (e.g., “education”). By focusing on relevant sections, system 100 can extract and map relevant named entities with greater confidence and accuracy.

Segmenting text 102 into text sections and separately processing the text sections can also reduce ambiguity. For example, a mention of “Python” in sections 502 and 504 likely refers to the Python programming language. In contrast, such a mention in a “Hobbies” section could refer to keeping the reptile as a pet. Other benefits of segmenting text 102 into text sections and separately processing the text sections include improved computational efficiency by avoiding further processing of text that is unlikely to contain relevant named entities, improved machine learning model training because the model can more effectively learn the different contexts in which named entities appear making the model better at generalizing to unseen text, enhanced post-processing such as weighting extracted named entities differently depending on which text section they are extracted from, and increasing granularity and precision (e.g., reduced false positives) where text 102 is a relatively large text and named entities are distributed sparsely within certain sections of text 102.

In some examples, domain-specific scorers (e.g., 150-1, 150-2, 150-3) correspond to different sections of domain-specific text 102 within a single more general text domain. As one example, where text 102 is a job description, there might be two domain-specific scorers in system 100, one for each of the following sections: “responsibilities” and “qualifications.” As another example, where text 102 is a resume, there might be two domain-specific scorers in system 100, one for each of the following sections: “past experiences” and “skills.” By having domain-specific scorers respectively focus on different sections of text 102 within a single more general text domain, system 100 may be more attuned to jargon and specific named entity terminology in the different sections of text 102 within that general text domain compared to where domain-specific scorers respectively focus on different more general text domains.

Segmenter 110 can segment text 102 into different sections in a variety of different ways including any one of or a combination of one or more of the following ways. Segmenter 110 can use a rule-based approach where sections in text 102 are identified using a predefined list of keywords that are commonly used in the text domain of text 102. For example, headers like “Experience,” “Education,” and “Skills” are commonly used in resumes. Segmenter 110 can conduct a layout analysis of text 102 such as by analyzing whitespace, layout patterns, fonts, font sizes, or other stylistic differences that may indicate sections of text 102. Segmenter 110 can use statistical approaches such as training a machine learning model to classify chunks of text 102 into different sections based on labeled training examples. Another possible statistical approach is to use a technique like Latent Dirichlet Allocation (LDA) to detect topics in different segments where each section of text 102 might have a different topic distribution. Segmenter 110 can use deep learning approaches such as sequence labeling models (e.g., Bidirectional LSTM or Transformer-based models) to label each line, paragraph, or other portion of text 102 with its corresponding section. Another possible deep learning approach is fine-tuning a pre-trained language model such BERT or GPT on a segmentation task to recognize and segment different sections of text 102.

Segmenter 110 is optional in some examples. For example, text 102 input to system 100 may already be a section of text and thus there is no need for segmenter 102 to further segment text 102 into sections. Or the nature of text 102 is such that it does not need to be segmented into sections. For example, text 102 can be a single sentence or a single paragraph or other short length text.

### Tagger

Tagger 120 extracts one or more named entities from an input text based on taxonomy 160. The input text can be text 102 or a section thereof segmented out by segmenter 110. The input text can be as short as a sentence or a phrase or as long as an entire document (e.g., an entire resume, learning course description, job description, or an entire section thereof).

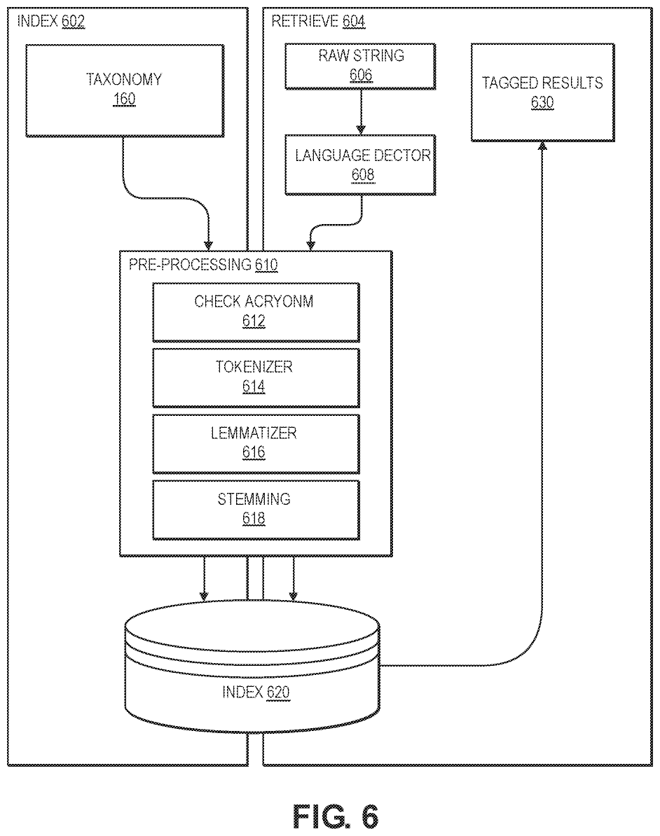

Two approaches employed by tagger 120 are disclosed for extracting named entities from the input text based on taxonomy 160. A first approach termed a “token-based matching approach” attempts to match tokens in the input text to identical or syntactically similar named entities in taxonomy 160. The token-based matching approach is discussed in greater detail below with respect to FIG. 6. A second approach termed a “semantic-based matching approach” attempts to map sentences, phrases, tokens, or other portions of the input text to semantically identical or semantically similar named entities in taxonomy 160. As one example, the semantic-based matching approach might map the phrase “experience with design of iOS applications” in the input text to the named entity “Mobile Development” in taxonomy 160.

A benefit of the token-based matching approach is that it is computationally efficient and hence scales well with large volumes of input texts. A drawback is that it is dependent on taxonomy 160 to contain all different real-world expressions of a named entity, which may not be practical or desirable. The semantic-based matching approach can complement the token-based matching approach or used as an alternative to the token-based matching approach. As described in greater detail below, the semantic-based matching approach uses trained machine learning models to understand contextual information in the input text and allowing for identification of named entities in taxonomy that are semantically identical or semantically similar to the input text or a portion of the input text even though they are not syntactically identical or syntactically similar.

### Token-Based Matching Approach

FIG. 6 illustrates a token-based matching approach for tagging named entities in the input text. The approach encompasses two phases: index 602 and retrieve 604. Index 602 phase occurs before retrieve 604 phase. During index 602 phase, named entities in taxonomy 160 are pre-processed 610 and the pre-processed named entities are stored in index 620. During retrieve 604 phase, raw string 606 (e.g., the input text or portion thereof) is input to language detector 608 which determines the natural language of raw string 606 (e.g., English, Spanish, Chinese, Portuguese, French, German, Japanese, Russian, Italian, Dutch, etc.). If a specification of the language does not accompany raw string 606 or if the language of raw string 606 is not otherwise known, various different approaches can be used by language detector 608 to determine the language of raw string 606 including any one of or a combination of two or more of the following language detection approaches: analyzing the frequency of character or word sequences (n-grams) in raw string 606; using statistical language models, such as n-gram or neural network-based models, to estimate the likelihood of raw string 606 belonging to a particular language; maintaining dictionaries or word lists for various languages and checking which one contains the most words from raw string 606; examining the character set and encoding used in raw string 606 where different languages have specific characters or character combinations that are more common; analyzing the frequency distribution of letters, words, or other linguistic elements in raw string 606; utilizing pre-built libraries and application programming interfaces (APIs) designed for language identification, such as Python's langdetect, nltk, or cloud-based natural language processing API; training machine learning models, such as Naive Bayes classifiers or deep learning models, on labeled multilingual text datasets to predict the language of raw string 606; analyzing the Unicode script used in raw string 606 to determine the likely language, as many languages share scripts (e.g., Latin script for English, Spanish, French, etc.); using statistical techniques to calculate various linguistic features (e.g., average word length, sentence length) and comparing them to language-specific norms; or any other suitable language detection approach.

Pre-processing 610, whether pre-processing as input a named entity from taxonomy 160 during index 602 phase or raw string 606 during retrieve 604 phase, may encompass one or more of acronym checking 612, tokenization 614, lemmatization 616, and stemming 618. Acronym checking 612 may include converting expanded forms in the input into their shorter length acronyms or converting acronyms in the input into their longer expanded forms. During index 602 phase, just the acronyms can be stored in index 620 in lieu of the expanded forms to reduce data storage and memory requirements for index 620 as the acronyms are shorter (fewer characters) than their expanded forms. This can also facilitate faster lookups based on the acronyms during retrieve 604 phase because the depth of the trie tree is reduced for the acronyms compared to their longer (more characters) expanded forms. Alternatively, both the acronyms and the expanded forms can be stored in index 620 to support searches based on both forms.

Tokenization 614 may include breaking down the input to pre-processing 610 into individual units or tokens, which can be words, phrases, symbols, or other meaningful elements. Lemmatization 616 may include reducing a word to its base or canonical form, known as a lemma. Stemming 618 may include removing suffixes or prefixes from words to obtain their root form, known as a stem. For a given named entity from taxonomy 160, index 620 may store different forms of the given named entity during index 602 phase to support searches by the different forms during retrieve 604 phase including any one of or two or more of the following forms: in raw form as stored in taxonomy 160, in acronym form (e.g., “NASA”) where the given named entity is the expanded form (e.g., “National Aeronautics and Space Administration”), in expanded form where the given named entity is in acronym form, in lemmatized form, in stemmed form, or any other suitable form. Each such form may be associated in index 620 with an identifier of the given named entity in taxonomy 160. The identifier may be used during retrieve 604 phase to obtain the given named entity from taxonomy 160 when a match to one of the forms is made during retrieve 604 phase.

During retrieve 604 phase, raw string 606 may be pre-processed 610 according to the language of raw string 606 detected by language detector 608. This pre-processing 610 may include acronym checking 612, tokenization 614, lemmatization 616, or stemming 618 of sequences of characters of raw string 606. The result of pre-processing 610 may include the sequences of characters and various forms of the sequences of characters such as acronym forms, expanded forms, lemmatized forms, stemmed forms, or combinations of such forms. Index 620 can be searched using the sequences of characters and their various forms to identify matches to sequences of characters in index 620. The matched character sequences from trie tree storage 620 are then provided as tagged results 630. In some examples, index 620 is implemented as a trie tree data structure where a path in the tree from a root node to a particular node provides the text string or text prefix associated with that node. The trie tree data structure may be used because it is particularly efficient for operations like matching of strings in a set when the set of strings contains strings with shared prefixes.

The output is a set of one or more tagged results 640 for raw string 606. Tagged results 630 may be reflected in a markup of raw string 606 where sequences of characters in raw string 606 are tagged with the associated named entities to which the sequences of characters were mapped during retrieve 604 phase. Such a tag may include one or both of the named entity itself or the identifier of the named entity in taxonomy 160 that can be used to retrieve the named entity from taxonomy 160 by downstream processing.

As a result of the token-based matching approach, raw string 606 from text 102 may be mapped to one or more named entities in taxonomy 160.

### Semantic-Based Matching Approach

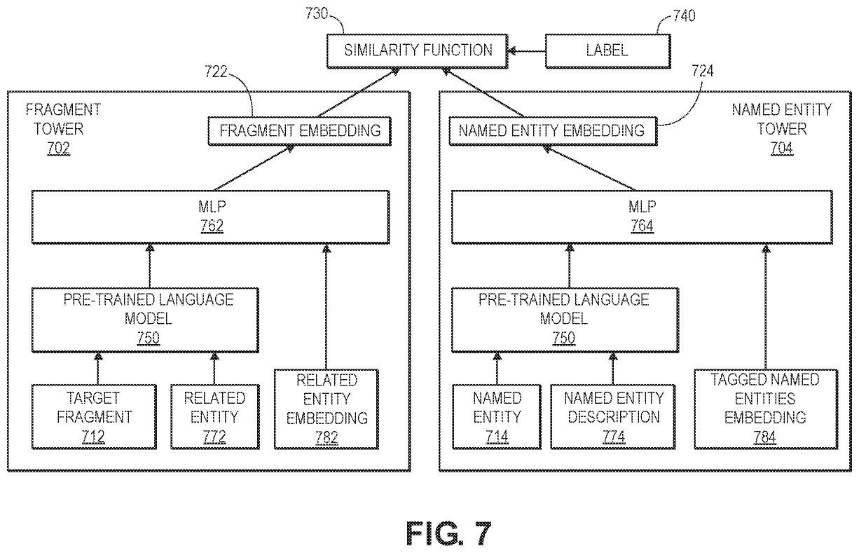

FIG. 7 illustrates a semantic-based matching approach for tagging named entities in a text. The approach is illustrated by example where the named entities are skills. However, the approach can be generalized to any category of named entities.

The approach uses a two-tower configuration including text fragment tower 702 and named entity tower 704. The input to text fragment tower 702 includes text fragment 712 from text 102 (e.g., a phrase, a sentence, or a paragraph from a section segmented from text 102 by segmenter 110.) While text fragment 712 can be a sentence it can instead be a phrase or other sequence of characters from text 102. Text fragment tower 702 generates text fragment embedding 722 for the input text fragment 712.

As a pre-processing operation, named entity embedding is generated for named entities in taxonomy 160 using named entity tower 704 (e.g., generated for each named entity in taxonomy 160). These generated named entity embeddings are stored in an index suitable for fast searching as part of the pre-processing operation. Examples of suitable indexes include approximate nearest neighbors (ANN) indexes that use locality-sensitive hashing (LSH) or product quantization; tree-based indexes that use space-partitioning data structures such as KD-trees and Ball Trees, or that use random projections such as Annoy; traditional database indexing techniques such as B-trees or bitmap indexes; specialized vector databases like as Milvus or Faiss designed specifically for vector embeddings; or any other suitable embedding index.

Text fragment embedding 722 generated by text fragment tower 702 for text fragment 712 can be used as a key into the embedding index containing the named entity embeddings generated by named entity tower 704. Using the index, text fragment embedding 722 can be matched to one or more of the most similar named entity embeddings in the index according to similarity function 730. For example, similarity function 730 can be based on cosine similarity, Euclidean distance, Manhattan distance, Minkowski distance, or other suitable embedding similarity function. The one or more named entities corresponding to the one or more most similar named entity embeddings can be determined as one or more named entities to which target text fragment 712 of text 102 is mapped.

Text fragment tower 702 and named entity tower 704 can be based on pre-trained language model 750. Pre-trained language model 750 can be pre-trained large-language model (LLM) text encoder such as a pre-trained multilingual Bidirectional Encoder Representations from Transformers (BERT) model that has been trained on text from multiple languages. In the case of text fragment tower 702, pre-trained language model 750 may generate an embedding (e.g., an M-BERT embedding) from target text fragment 712 and possibly from one or more related entities 772. A related entity 772 can be a text entity related to text 102. For example, in the case where text 102 is a job description, a related entity 772 might be the title of the job. In the case of named entity tower 704, pre-trained language model 750 may generate an embedding (e.g., an M-BERT embedding) from named entity 714 and named entity description 774 obtained from taxonomy 160. Named entity description 774 is a short description (e.g., phrase, sentence, or paragraph) of named entity 714. For example, a description of “machine learning” might be “machine learning is a subset of artificial intelligence (AI) that involves the development of algorithms and models that enable computers to learn from and make predictions or decisions based on data.”

Text fragment tower 702 includes a trained multi-layer perceptron (MLP) 762 that generates text fragment embedding 722 from the embedding output by pre-trained language model 750 of text fragment tower 702. In addition, trained MLP 762 may generate text fragment embedding 772 based on one or more input related entities embeddings 782. A related entity embedding 782 may represent a related entity 772. For example, a related entity embedding 782 may be a vector representation of a job title where the text of the job title is one of related entities 772. The trained MLP 762 processes the input embedding or embeddings and generates text fragment embedding 722 for the input target text fragment 712 as a result.

Likewise, named entity tower 704 includes its own trained multi-layer perceptron (MLP) 764 that generates named entity embedding 724 from the embedding output by pre-trained language model 750 of named entity tower 704. In addition, one or more tagged named entity embeddings 784 may be input to MLP 764 along with the embedding output by pre-trained language model 750 of named entity type 704. Each tagged named entity embedding 784 represents an named entity that has been tagged in text.

Label 740 represents the training label when jointly training MLP 762 and MLP 764. For example, the training data set may encompass pairs of inputs where one input of the pair is to text fragment tower 702 and includes a target text fragment 712, one or more related entities 772, and one or more related entity embeddings 782 and the other input of the pair is to named entity tower 704 and includes a named entity 714, a named entity description 774, and one or more tagged named entity embeddings 784. Each pair may be labeled by a respective label 740 which indicates how similar the text fragment embedding 722 generated by text fragment tower 702 for the input of the pair should be to the named entity embedding 724 generated by named entity tower 704 for the input of the pair. For example, the label 740 can be binary label that indicates that the embeddings 722 and 724 generated by towers 702 and 704 for the pair should be similar or not similar. As another example, the label 740 may be a numerical value corresponding to the output of the similarity function 730 that numerically indicates the degree of similarity between the embeddings 722 and 724 generated by the towers 702 and 704 for the pair.

### Expander

After tagger 120 has processed text 102 or a section thereof, system 100 obtains a set of one or more named entities in taxonomy 160 from tagger 120 to which text 102 or the section is mapped by tagger 120 (e.g., using either or both the token-based mapping approach of FIG. 6 and the semantic-based mapping approach of FIG. 7.) This set of named entities can be expanded by expander 130 to include one or more additional named entities from taxonomy 160 thereby effectively mapping text 102 of the section to additional named entities in taxonomy 160. Such expansion provides more potentially relevant named entity candidates for encoding and scoring by shared encoder 140 and domain-specific scorers 150.

Expander 140 can expand a named entity output by tagger 120 for text 120 or a section thereof by identifying one or more related named entities in taxonomy 160. A related named entity can be a parent named entity, a child named entity, or a sibling named entity (same parent) in the hierarchy of named entities in taxonomy 160. For example, expander 140 can expand a named entity output by tagger 120 into its parent named entity in taxonomy 160 if there is one, all of its child named entities in taxonomy 160 if there are any, and all of its sibling named entities in taxonomy 160 if there are any.

### Shared Encoder

As a result of processing text 102 or a section thereof by tagger 120 and expander 130, a set of one or more candidate named entities from taxonomy 160 are obtained by system 100. Shared encoder 140 and domain-specific scorers 150 are used by system 100 to score each of the candidate named entities as to relevance to text 102.

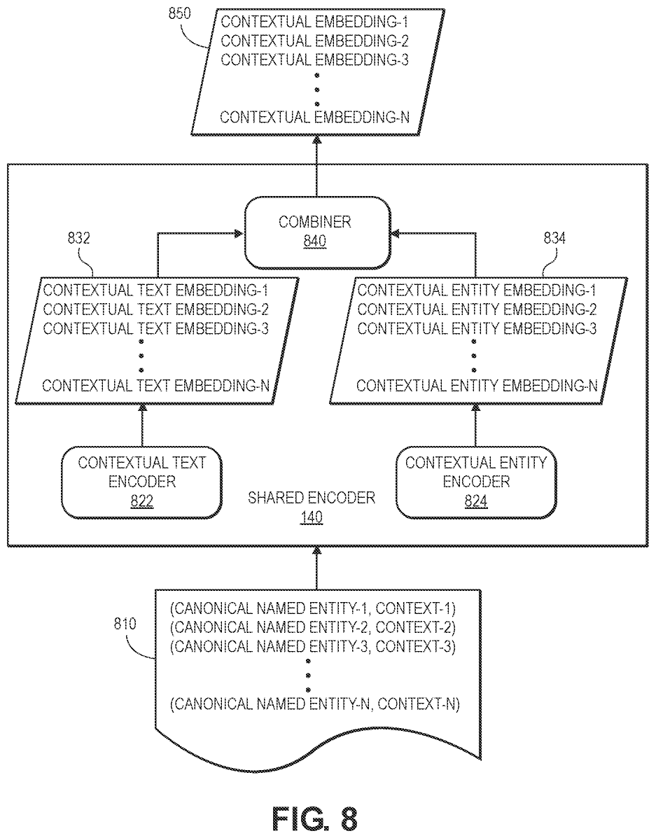

FIG. 8 illustrates shared contextual encoder model 140 in greater detail. Encoder 140 includes contextual text encoder 822 and contextual entity encoder 824. Input to encoder 140 is a set of canonical named entity and text context pairs 810. Each canonical named entity is either a named entity to which text 102 was mapped by tagger 120 or a named entity expanded by expander 130 from a named entity mapped by tagger 120. Each named entity in pairs 810 is canonical in the sense that it is from taxonomy 160.

The text context of a pair of pairs 810 is a portion of text 102 from which the associated canonical named entity of the pair or an underlying canonical named entity was extracted by tagger 120. The portion can be a phrase, sentence, paragraph, or section of text 102, or the entirety of text 102, or other sequence of characters of text 102 from which the associated canonical named entity of the pair or an underlying canonical named entity was extracted by tagger 120. In the case the associated canonical named entity of a pair of pairs 810 is determined by expander 130, tagger 120 extracted an underlying canonical named entity from the text content of the pair.

Contextual text encoder 822 is a deep machine learning model such as a transformer-based encoder or other deep machine learning language model encoder that takes as input a canonical named entity and text context pair and produces as output a contextual text embedding reflecting a context of the input canonical named entity in the input text context. Contextual text encoder 822 can generate a contextual text embedding for each canonical named entity and text context pair of pairs 810 to produce corresponding contextual text embeddings 832. One contextual text embedding of embeddings 832 can be generated by contextual text encoder 822 for each pair of pairs 810. For a given pair of pairs 810, the input to contextual text encoder 822 can include the canonical named entity of the pair and the text context of the pair. The input can also include additional text context. For example, the additional text content can incorporate other text reflecting available information about a text portion of text 102 or text 102. The available information may vary depending on the text domain of text 102. For example, where text 102 is a job description, the additional text context may include a job title. As another example, where text 102 is a resume, the additional text context may include a description or title of the most recent job held by the person whose resume it is. Thus, the input text context to contextual text encoder 822 for a pair of pairs 810 may include the text context of the pair and additional text context.

Contextual text encoder 822 may have an input layer that accepts a canonical named entity and associated text context. Contextual text encoder 822 may pre-process the text inputs such as by breaking down the text inputs into tokens (e.g., tokenization) and adding positional information (e.g., positional encoding). Contextual text encoder 822 may have an embedding layer that transforms the tokenized input into dense vectors using pre-trained embeddings like Word2Vec, GloVe, or embeddings from models like BERT, ROBERTa, etc.

Contextual text encoder 822 may have a contextual encoding layer that uses attention mechanisms to derive context-aware embeddings. For example, the contextual encoding layer may encompass transformer blocks (e.g., BERT). The attention mechanism may give weight to tokens from the input text context that are contextually relevant to the input canonical named entity. For example, the contextual encoding layer may compute attention scores based on the proximity or relevance of tokens in the input text context to the input canonical named entity. The context-aware embeddings generated for tokens in the input text context may be aggregated by contextual text encoder 822 to form a single vector representation. For example, the context-aware embeddings can be aggregated by max-pooling, average-pooling, or a weighted sum based on attention scores. The final aggregated vector is output by contextual text encoder 822 as the context text embedding for the input canonical named entity and text context pair.

Contextual entity encoder 824 utilizes pre-calculated entity embeddings to provide entity level context for a canonical named entity and text content input pair. Other features such as co-occurrence rates between named entities may also be input. Contextual text encoder 824 can generate a contextual entity embedding for each canonical named entity and text context pair of pairs 810 to produce corresponding contextual entity embeddings 834. One contextual entity embedding of embeddings 834 can be generated by contextual entity encoder 824 for each pair of pairs 810. For a given pair of pairs 810, the input to contextual entity encoder 824 can include the canonical named entity of the pair and the text context of the pair.

The input to contextual entity encoder 824 can additionally include a set of one or more pre-calculated entity embeddings. The pre-calculated entity embeddings that are input may depend on the text domain of text 102. For example, where the text domain pertains to resumes, learning course descriptions, or job descriptions, the set of pre-calculated entity embeddings might include pre-calculated skill embeddings, title embeddings, industry embeddings, geographical embeddings, among other possible entity embeddings. Manual features, such as co-occurrence rates between named entities, can also be input to contextual entity encoder 824.

Contextual entity encoder 824 may have an input layer that accepts a canonical named entity, associated text context, a set of one or more pre-calculated entity embeddings, and co-occurrence rates between named entities are input. Contextual entity encoder 824 may pre-process the text inputs such as by breaking down the text inputs into tokens (e.g., tokenization) and adding positional information (e.g., positional encoding). Contextual entity encoder 824 may have an embedding layer that transforms the tokenized text inputs into dense vectors using pre-trained embeddings like Word2Vec, GloVe, or embeddings from models like BERT, ROBERTa, etc.

Contextual entity encoder 824 may have a contextual encoding layer that combines the text input embeddings and the pre-calculated entity embeddings and integrates with the co-occurrence features. Multiple transformer blocks (e.g., as in a BERT model) may be used by contextual entity encoder 824 to generate context-aware embeddings. Contextual entity encoder 824 may apply an attention mechanism that weights tokens based on their relevance. Contextual entity encoder 824 include an aggregation layer that uses pooling techniques such as max-pooling, average pooling, or attention-based pooling to condense the context-aware embeddings into a single contextual entity embedding for the input canonical named entity and text context pair.

Combiner 840 may pairwise combine contextual text embeddings 832 output by contextual text encoder 822 and contextual entity embeddings 834 output by contextual entity encoder 824 to generate contextual embeddings 850. For example, combiner 840 may combine contextual text embedding-1 of embeddings 823 and contextual entity embedding-1 of embeddings 834 generated for the (canonical named entity pair-1, context-1) pair of pairs 8110 into contextual embedding-1 of embeddings 850. Likewise, combiner 840 may combine contextual text embedding-2 of embeddings 823 and contextual entity embedding-2 of embeddings 834 generated for the (canonical named entity pair-2, context-2) pair of pairs 8110 into contextual embedding-2 of embeddings 850, and so on for all pairs 810. Combiner 840 may combine two embeddings in various ways including: by concatenating, by averaging, by weighted averaging, by max pooling, by min pooling, by summing, by multiplication, by a combination of multiple methods such as concatenating the average and max pooling of the embeddings, by using an attention mechanism that gives different weights to different parts of the embeddings based on their importance in context, by using principal component analysis (PC) or other dimensionality reduction techniques, by using a neural network to learn the optimal way to combine the embeddings, or any other suitable way.

### Domain Specific Scorers

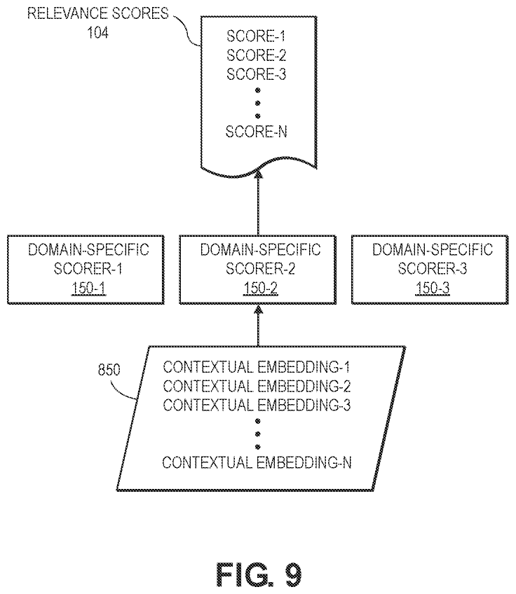

Turning now to FIG. 9, it illustrates domain-specific scorers 150-1, 150-2, and 150-3. Contextual embeddings 850 output by shared encoder model 140 are input to one of domain-specific scorers 150-1, 150-2, and 150-3. In particular, contextual embeddings 850 are input to the domain-specific scorer 150-1, 150-2, or 150-3 for the text domain of text 102. Each contextual embedding of contextual embeddings 850 is for one canonical named entity of pairs 810. Each domain-specific scorer is trained to score each contextual embedding where the score represents the relevance of the corresponding canonical named entity to text 102. For example, the relevance score can be a value between 0 and 1 where 0 represents no relevance and 1 represents the maximum possible relevance (e.g., highly relevant or very relevant). Each contextual embedding of embeddings 850 can be scored by the target domain-specific scorer to yield relevance scores 104, one relevance score for each canonical named entity of pairs 810. Relevance scores 104 along with the scored canonical named entities can be provided to another system for further processing such as, for example, recommending one or more of the best scoring canonical named entities.

In some examples, the text domain of text 102 may be unknown. Contextual embeddings 850 can be input to each of domain-specific scorers 150-1, 150-2, and 150-3 and a respective set of relevance scores obtained from each scorer 150-1, 150-2, and 150-3. The text domain of text 102 can be determined by system 100 as the one corresponding to the domain-specific scorer 150-1, 150-2, or 150-3 that produced the highest (best) relevance scores (e.g., on average or with the best relevance score). Those relevance scores from that domain-specific scorer can then be provided to a system for further processing.

Each domain-specific scorer may be a neural network that includes an input layer, one or more hidden layers, and an output layer. The input accepts a number of inputs equal to the dimensionality of a contextual embedding of embeddings 850. The hidden or intermediate layers of the domain-specific scorer may include fully connected (dense) layers. A hidden layer may apply weights, biases, and a non-linear activation function such as ReLU, sigmoid, tanh, etc. to its inputs. Dropout, normalization, or other regularization techniques may be applied to prevent overfitting. The output layer may include a single neuron that produces the score. An activation function may be applied to produce the score such as a sigmoid activation to produce a score between 0 and 1.

### Domain-Specific Joint Training

Shared encoder model 140 and domain-specific scorer models 150-1, 150-2, and 150-3 can be jointly trained. The models can be trained on a training dataset that encompasses training examples for all text domains to which scorer models 150-1, 150-2, and 150-3 correspond. When joint training, training loss for all examples can be backpropagated (e.g., gradients of the training loss may be computed using backpropagation) to shared model 140. However, training loss may be backpropagated to a domain-specific scorer model 150-1, 150-2, or 150-3 only for those training examples that correspond to that domain-specific scorer model. By doing so, shared encoder model 140 is trained to generalize well across all text domains while each domain-specific scorer model 150-1, 150-2, and 150-3 is trained to generalize well for its particular text domain. This allows the system 100 to better learn general patterns that span all text domains as well as the nuances of each individual text domain.

For example, consider where the text domains are resumes, job descriptions, and learning course descriptions. A training dataset may encompass examples from each of those text domains. When training, training loss may be backpropagated to shared encoder model 140 for all examples. However, training loss for training examples in the resumes text domain may be backpropagated to just to the domain-specific scorer model (e.g., 150-1) for the resumes text domain, training loss for training examples in the job descriptions text domain may be backpropagated to just to the domain-specific scorer model (e.g., 150-2) for the job descriptions text domain, and training loss for training examples in the learning course descriptions text domain may be backpropagated to just to the domain-specific scorer model (e.g., 150-3) for the learning course descriptions text domain.

### Example Use Cases

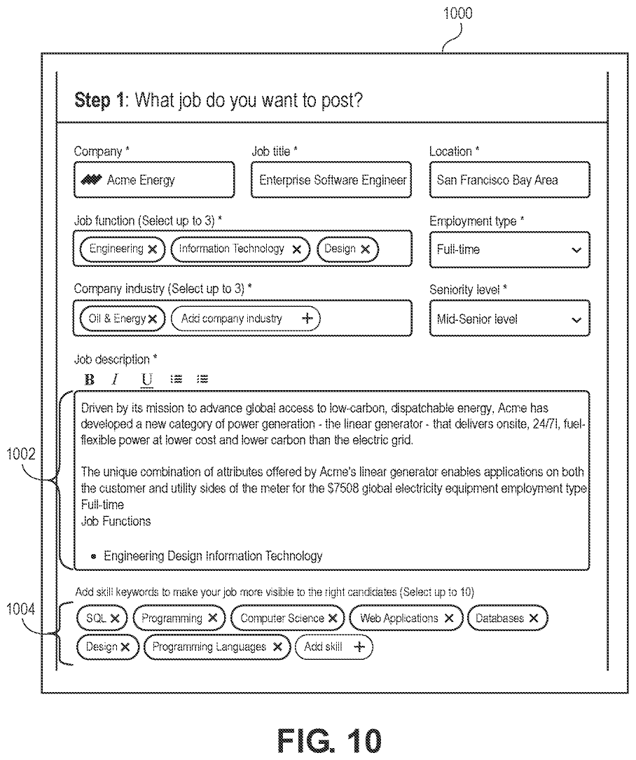

FIG. 10 illustrates an example use case of domain-specific named entity extraction and mapping. A graphical user interface 1000 or GUI 1000 is presented to a user. GUI 1000 prompts the user for information about a job to be posted to an online job board. The user may be an employer looking to hire or a recruiter for an open position, for example. The user has provided description 1002 of the job. The text of job description 1002 may be input to system 100 of FIG. 1 to determine relevance scores 104 of skills 1004 that are most relevant to job description 1002. A system receiving relevance scores 104 scoring skills 1004 can recommend skills 1004 to the user to add as keywords to associated with the job posting to make the job posting more visible to the right candidates using the online job board where the online job board system recommends or suggests job postings to candidates based on matching skills between the job postings and the candidates.

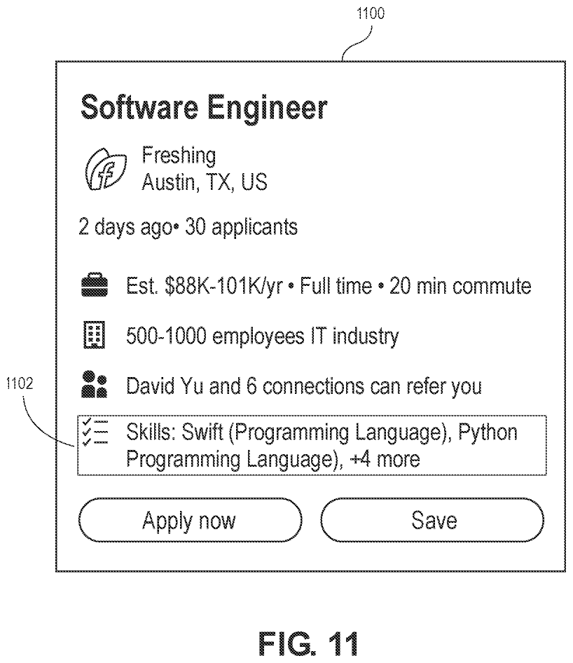

FIG. 11 illustrates another example use case of domain specific named entity extraction and mapping. In this example, a user of an online job board is viewing a graphical user interface 1100 or GUI 110 that presents a job opening. The text of the viewing user's profile (e.g., encompassing a resume of the viewing user) may be input to system 100 to determine a first set of relevance scores 104 for a first set of skills that are relevant to the viewing user's profile. The text of the job description of the job opening can also be input to system 100 determine a second set of relevance scores 104 for a second set of skills that are relevant to the job opening. Top scoring skills 1102 in the second set of skills that are relevant to the job opening that match top scoring skills in the first set of skills that are relevant to the viewing user's profile are presented in GUI 1100 so that the viewing user can see how well their skills matching up with the skills required by the job.

### Example Method

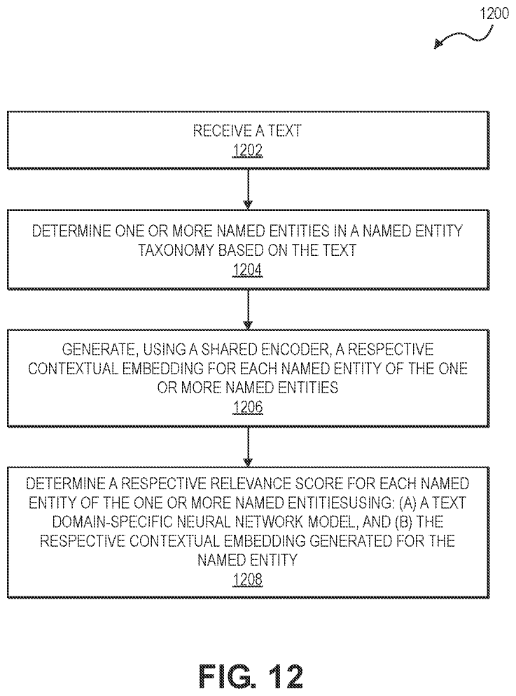

FIG. 12 is a flowchart of an example method for domain-specific named entity extraction and mapping. In FIG. 12 and other flowcharts herein, the ordering of the steps is one example and other orders are possible, not all steps are required, and steps may be combined or divided. The methods described by any flowcharts described herein may be implemented, for example, by any of the computers or systems described herein.

At block 1202, a text is received. The received text can be as short as a phrase or sentence or as long as a multi-page document. For example, the received text can be a resume, a job posting, or a learning course description or a sentence or phrase thereof.

At block 1204, one or more named entities in a named entity taxonomy are determined based on the text. For example, a named entity of the one or more named entities can be determined using the token-based matching approach, the semantic-based matching approach, or the expander as described above.

At block 1206, a shared encoder (e.g., shared encoder 140) generates a respective contextual embedding for each named entity of the one or more named entities. For example, the shared encoder can generate the respective contextual embeddings using the approach described above with respect to FIG. 8.

At block 1208, a respective relevance score is determined for each named entity of the one or more named entities using a text domain-specific machine learning model and the respective contextual embedding generated by the named entity by the shared encoder. For example, the relevance score(s) can be determined for the one or more named entities using the approach described above with respect to FIG. 9.

At block 1210, the determined relevance score(s) are provided to a computer system for further processing. For example, the computer system may recommend one or more of the named entities based on their respective relevance score(s). The recommendation may be presented in a graphical user interface to a user of a computing device, for example. The user may act on the recommendation. For example, a recruiter for a job opening may be recommended one or more skill keywords (tags) to associated with an online job posting based on a job description authored by the recruiter. Or a user of an online professional network may be recommended one or more skill keywords (tags) to add to their online profile based on a resume of the user uploaded to the profession network system.

### Example Programmable Electronic Device

FIG. 13 illustrates an example of a programmable electronic device that processes and manipulates data to perform tasks and calculations disclosed herein for domain-specific named entity extraction and mapping. Example programmable electronic device 1300 includes central processing unit (CPU) 1302, main memory device 1304, memory device 1306, input device 1308, output device 1310, data storage device 1312, and network interface device 1314 all connected to bus 1316. While only one of each type of device connected to the bus 1316 is depicted in FIG. 13 for the purpose of providing a clear example, multiple instances of each of one or more of these devices may be connected to bus 1316. Further, some devices may not be present in a particular instance of device 1300. For example, device 1300 in a headless configuration such as, for example, when operating as a server racked in a data center may not be connected to or include input device 1308 and output device 1310.

CPU 1302 interprets and executes instructions 1318 including instructions 1320 for domain-specific named entity extraction and mapping. CPU 1302 may fetch, decode, and execute instructions 1318 from main memory device 1304. CPU 1302 performs arithmetic and logic operations and coordinates the activities of other hardware components of device 1300. CPU 1302 may include a cache used to store frequently accessed data and instructions 1318 to speed up processing. CPU 1302 may have multiple layers of cache (L1, L2, L3) with varying speeds and sizes. CPU 1302 may be composed of multiple cores which each such core is a processing unit within CPU 1302. The cores allow CPU 1302 to execute multiple instructions 1318 at once in a parallel processing manner. CPU 1302 may support multi-threading where each core of CPU 1302 can handle multiple threads (multiple sequences of instructions) at once to further enhance parallel processing capabilities. CPU 1302 may be made using silicon wafers according to a manufacturing process (e.g., 7 nm, 5 nm). CPU 1302 can be configured to understand and execute a set of commands referred to as an instruction set architecture (ISA) (e.g., x86, x86_64, or ARM).

Main memory device 1304 (sometimes referred to as “main memory” or just “memory”) holds data and instructions 1318 that CPU 1302 uses or processes. Main memory device 1304 provides the space for the operating system, applications, and data in current use to be quickly reached by CPU 1302. Main memory device 1304 may be a random-access memory (RAM) device that allows data items to be read or written in substantially the same amount of time irrespective of the physical location of the data items inside the main memory device 1304.

Main memory device 1304 can be a volatile or non-volatile memory device. Data stored in a volatile memory device is lost when the power is turned off. Data in a non-volatile memory device remains intact even when the system is turned off. For example, main memory device 1304 can be a Dynamic RAM (DRAM) device. A DRAM device such as a Single Data Rate RAM (SDRAM) device or Double Data Rate RAM (DDRAM) is a volatile memory device that stores each bit of data in a separate capacitor within an integrated circuit. The capacitors leak charge and need to be periodically refreshed to avoid information loss. Additionally, or alternatively, main memory device 1304 can be a Static RAM (SRAM) device. A SRAM device is a volatile memory device that is typically faster but more expensive than DRAM. SRAM uses multiple transistors for each memory cell but does not need to be periodically refreshed. Additionally, or alternatively, a SRAM device may be used for cache memory in CPU 1302.

Device 1300 can have memory device 1306 other than main memory device 1304. Examples of memory device 1306 include a cache memory device, a register memory device, a read-only memory (ROM) device, a secondary storage device, a virtual memory device, a memory controller device, and a graphics memory device.

A cache memory device may be found inside or very close to CPU 1302 and is typically faster but smaller than main memory device 1304. A cache memory device may be used to hold frequently accessed data and instructions 1318 to speed up processing. A cache memory device is usually hierarchical ranging from a Level 1 cache memory device which is the smallest but fastest cache memory device and is typically inside CPU 1302 to Level 2 and Level 3 cache memory devices which are progressively larger and slower cache memory devices that can be inside or outside CPU 1302.

A register memory device is a small but very fast storage location within CPU 1302 designed to hold data temporarily for ongoing operations.

A ROM device is a non-volatile memory device that can only be read, not written to. For example, a ROM device can be a Programmable ROM (PROM) device, an Erasable PROM (EPROM) device, or an electrically erasable PROM (EEPROM) device. A ROM device may store basic input/output system (BIOS) instructions which help device 1300 boot up.

A secondary storage device is a non-volatile memory device. For example, a

secondary storage device can be a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device.

A virtual memory device is a portion of a hard drive or an SSD that the operating system uses as if it were main memory device 1304. When main memory device 1304 get filled, less frequently accessed data and instructions 1318 can be “swapped” out to the virtual memory device. The virtual memory device is slower than main memory device 1304, but it provides the illusion of having a larger main memory device 1304.

A memory controller device manages the flow of data and instructions 1318 to and from main memory device 1304. A memory control device can be located either on the motherboard of device 1300 or within CPU 1302.

A graphics memory device is used by a graphics processing unit (GPU) (not shown) and is specially designed to handle the rendering of images, videos, and graphics. Examples of a graphics memory device include a graphics double data rate (GDDR) device such as a GDDR5 device and a GDDR6 device.

Input device 1308 is an electronic component that allows users to feed data and control signals into device 1300. Input device 1308 translates a user's action or the data from the external world into a form that device 1300 can process. Examples of input device 1308 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1310 is an electronic component that conveys information from device 1300 to the user or to another device. The information can be in the form of text, graphics, audio, video, or other media representation. Examples of an output device 1310 include a monitor or display device, a printer device, a speaker device, a headphone device, a projector device, a plotter device, a braille display device, a haptic device, a LED or LCD panel device, a sound card, and a graphics or video card.

Data storage device 1312 may be an electronic device that is used to store data and instructions 1318. Data storage device 1312 may be a non-volatile memory device. Examples of data storage device 1312 include a hard disk drive (HDD), a solid-state drive (SDD), an optical drive, a flash memory device, a magnetic tape drive, a floppy disk, an external drive, or a RAID array device. Data storage device 1312 could additionally or alternatively be connected to device 1300 via network 1322. For example, data storage device 1312 could encompass a network attached storage (NAS) device, a storage area network (SAN) device, or a cloud storage device.

Network interface device 1314 (sometimes referred to as a network interface card, NIC, network adapter, or network interface controller), is an electronic component that connects device 1300 to network 1322. Network interface device 1314 functions to facilitate communication between device 1300 and network 1322. Examples of a network interface device 1314 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1316 is a communication system that transfers data between electronic components of device 1300. Bus 1316 serves as a shared highway of communication for data and instructions (e.g., instructions 1318), providing a pathway for the exchange of information between components within device 1300 or between device 1300 and another device. Bus 1316 connects the different parts of device 1300 to each other. Examples of bus 1316 include a system bus, a front-side bus, a data bus, an address bus, a control bus, an expansion bus, a universal serial bus (USB), a I/O bus, a memory bus, an internal bus, and an external bus.

Instructions 1318 are computer-executable instructions that can take different forms. Instructions 1318 can be in a low-level form such as binary instructions, assembly language, or machine code according to an instruction set (e.g., x86, ARM, MIPS) that CPU 1302 is designed to execute. Instructions 1318 can include individual operations that CPU 1302 is designed to perform such as arithmetic operations (e.g., add, subtract, multiply, divide, etc.); logical operations (e.g., AND, OR, NOT, XOR, etc.); data transfer operations including moving data from one location to another such as from main memory device 1304 into a register of CPU 1302 or from a register to main memory device 1304; control instructions such as jumps, branches, calls, and returns; comparison operations; and specialization operations such as handling interrupts, floating-point arithmetic, and vector and matrix operations. Instructions 1318 can be in a higher-level form such as programming language instructions in a high-level programming language such as Python, Java, C++, etc. Instructions 1318 can be in an intermediate level form in between a higher-level form and a low-level form such as bytecode or an abstract syntax tree (AST).

Instructions 1318 for execution by CPU 1302 can be in different forms at the same or different times. For example, when stored in data storage device 1312 or main memory device 1304, instructions 1318 for execution by CPU 1302 may be stored in a higher-level form such as Python, Java, or other high-level programing language instructions, in an intermediate-level form such as Python or Java bytecode that is compiled from the programming language instructions, or in a low-level form such as binary code or machine code. When stored in CPU 1302, instructions 1318 for execution by CPU 1302 may be stored in a low-level form. However, instructions 1318 for execution by CPU 1302 may be stored in CPU 1302 in an intermediate level form where CPU 1302 can execute instructions in such form.

Network 1322 is a collection of interconnected computers, servers, and other programmable electronic devices that allow for the sharing of resources and information. Network 1322 can range in size from just two connected devices to a global network (e.g., the internet) with many interconnected devices. Individual devices on network 1322 are sometimes referred to as “network nodes.” Network nodes communicate with each other through mediums or channels sometimes referred to as “network communication links.” The network communication links can be wired (e.g., twisted-pair cables, coaxial cables, or fiber-optic cables) or wireless (e.g., Wi-Fi, radio waves, or satellite links). Network 1322 may encompass network devices such as routers, switches, hubs, modems, and access points. Network nodes may follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol). Network 1322 may have a particular physical or logical layout or arrangement sometimes referred to as a “network topology.” Example network topologies include bus, star, ring, and mesh. Network 1322 can be different of different sizes and scopes. For example, network 1322 can encompass some or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

As used herein, the term “computer-readable media” refers to one or more mediums or devices that can store or transmit information in a format that a computer system can access. Computer-readable media encompasses both storage media and transmission media. Storage media includes volatile and non-volatile memory devices such as RAM devices, ROM devices, secondary storage devices, register memory devices, memory controller devices, graphics memory devices, and the like.

The term “non-transitory computer-readable media” as used herein refers to computer-readable media as just defined but excluding transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

### Terminology

As used herein and in the appended claims, unless otherwise clear in context, the terms “comprising,” “having,” “containing,” “including,” “encompassing,” “in response to,” “based on,” etc. are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment.

As used herein, unless otherwise clear in context, the term “or” is open-ended and encompasses all possible combinations, except where infeasible. For example, if it is stated that a component may include A or B, then, unless infeasible or otherwise clear in context, the component may include at least A, or at least B, or at least A and B. As a second example, if it is stated that a component may include A, B, or C then, unless infeasible or otherwise clear in context, the component may include at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. can be either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical or causal connection or association between two stated things where one of the things is the basis for or informs the other without requiring or foreclosing additional unstated things that affect the logical or casual connection or association between the two stated things.

Unless the context clearly indicates otherwise, the relational term “in response to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### Privacy and Bias

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a text;
determining one or more named entities based on the text, the one or more named entities in a named entity taxonomy;
generating, using a shared encoder, a respective contextual embedding for each named entity of the one or more named entities;
determining a respective relevance score for each named entity of the one or more named entities using: (a) a text domain-specific machine learning model, and (b) the respective contextual embedding generated for the named entity; and
providing the respective relevance score determined for a named entity of the one or more named entities to a named entity recommendation system for further processing.

2. The method of claim 1, wherein determining one or more named entities based on the text comprises determining a named entity of the one or more named entities based on:
matching a sequence of characters of the text to a sequence of characters associated with the named entity in an index data structure.

3. The method of claim 1, wherein determining one or more named entities based on the text comprises determining a named entity of the one or more named entities based on:
generating a first embedding representing the named entity;
generating a second embedding representing a portion of the text; and
comparing the first embedding to second embedding according to a similarity function.

4. The method of claim 1, wherein generating, using the shared encoder, the respective contextual embedding for each named entity of the one or more named entities comprises generating, using the shared encoder, a respective contextual embedding for a named entity of the one or more named entities based on:
generating, by a contextual text encoder of the shared encoder, a contextual text embedding for the named entity;
generating, by a contextual entity encoder of the shared encoder, contextual entity embedding for the named entity; and
combining the contextual text embedding and the contextual entity embedding to yield the respective contextual embedding for the named entity.

5. The method of claim 1, further comprising:
determining a text domain of a plurality of pre-determined text domains to which the text belongs; wherein each text domain of the plurality of pre-determined text domains corresponds to a respective text domain-specific machine learning model; and
selecting the text domain-specific machine learning model to use to determine the respective relevance score for each named entity of the one or more named entities based on the determined text domain to which the text belongs.

6. The method of claim 1, wherein determining the one or more named entities based on the text comprises determining a parent named entity, a sibling named entity, or a child named entity in the named entity taxonomy of a named entity of the one or more named entities.

7. The method of claim 1, wherein the named entity recommendation system to which the respective relevance score determined for the named entity is provided determines to recommend the named entity based on the respective relevance score.

8. A system, comprising:
at least one computer comprising at least one processor and at least one memory, the at least one computer configured to:
receive a text belonging to a particular text domain;
determine one or more named entities based on the text, the one or more named entities in a named entity taxonomy;
generating, using a shared encoder, a respective contextual embedding for each named entity of the one or more named entities;
determine a respective relevance score for each named entity of the one or more named entities using: (a) a text domain-specific neural network model specific to the particular text domain to which the text belongs, and (b) the respective contextual embedding generated for the named entity; and
send the respective relevance score determined for a named entity of the one or more named entities to a named entity recommendation system for further processing.

9. The system of claim 8, wherein the at least one computer configured to determine one or more named entities based on the text comprises at least one computer configured to determine a named entity of the one or more named entities based on:
matching a sequence of characters of the text to a sequence of characters associated with the named entity in an index.

10. The system of claim 8, wherein the at least one computer configured determine one or more named entities based on the text comprises at least one computer configured determine a named entity of the one or more named entities based on:
generating a first embedding representing the named entity;
generating a second embedding representing a portion of the text; and
comparing the first embedding to second embedding according to a similarity function.

11. The system of claim 8, wherein the at least one computer configured to generate, using the shared encoder, the respective contextual embedding for each named entity of the one or more named entities comprises at least one computer configured to generate, using the shared encoder, a respective contextual embedding for a named entity of the one or more named entities based on:
generating, by a contextual text encoder of the shared encoder, a contextual text embedding for the named entity;
generating, by a contextual entity encoder of the shared encoder, contextual entity embedding for the named entity; and
combining the contextual text embedding and the contextual entity embedding to yield the respective contextual embedding for the named entity.

12. The system of claim 8, further comprising at least one computer configured to:
determine a text domain of a plurality of pre-determined text domains to which the text belongs; wherein each text domain of the plurality of pre-determined text domains corresponds to a respective text domain-specific machine learning model; and
select the text domain-specific machine learning model to use to determine the respective relevance score for each named entity of the one or more named entities based on the determined text domain to which the text belongs.

13. The system of claim 8, wherein the at least one computer configured to determine the one or more named entities based on the text comprises at least one computer configured to determine a parent named entity, a sibling named entity, or a child named entity in the named entity taxonomy of a named entity of the one or more named entities.

14. The system of claim 8, wherein the named entity recommendation system to which the respective relevance score determined for the named entity is provided is configured to determine to recommend the named entity based on the respective relevance score.

15. One or more non-transitory computer-readable media comprising computer-executable instructions that, when executed, cause at least one processor to perform actions comprising:
receiving a text;
determining a text domain to which the text belongs;
determining one or more named entities based on the text, the one or more named entities in a named entity taxonomy;
generating, using a shared encoder, a respective contextual embedding for each named entity of the one or more named entities;
determining a respective relevance score for each named entity of the one or more named entities using: (a) a text domain-specific machine learning model specific to the text domain to which the text belongs, and (b) the respective contextual embedding generated for the named entity; and
providing the respective relevance score determined for a named entity of the one or more named entities to a named entity recommendation system for further processing.

16. The one or more non-transitory computer-readable media of claim 15, further comprising determining one or more named entities based on the text comprises determining a named entity of the one or more named entities based on:
matching a sequence of characters of the text to a sequence of characters associated with the named entity in an index.

17. The one or more non-transitory computer-readable media of claim 15, wherein computer-executable instructions that, when executed, cause at least one processor to perform determining one or more named entities based on the text further comprise computer-executable instructions that, when executed, cause at least one processor to perform determining a named entity of the one or more named entities based on:
generating a first embedding representing the named entity;
generating a second embedding representing a portion of the text; and
comparing the first embedding to second embedding according to a similarity function.

18. The one or more non-transitory computer-readable media of claim 15, wherein computer-executable instructions that, when executed, cause at least one processor to perform generating, using the shared encoder, the respective contextual embedding for each named entity of the one or more named entities further comprise computer-executable instructions that, when executed, cause at least one processor to perform generating, using the shared encoder, a respective contextual embedding for a named entity of the one or more named entities based on:
generating, by a contextual text encoder of the shared encoder, a contextual text embedding for the named entity;
generating, by a contextual entity encoder of the shared encoder, contextual entity embedding for the named entity; and
combining the contextual text embedding and the contextual entity embedding to yield the respective contextual embedding for the named entity.

19. The one or more non-transitory computer-readable media of claim 15, further comprising computer-executable instructions that, when executed, cause at least one processor to perform:
determining a text domain of a plurality of pre-determined text domains to which the text belongs; wherein each text domain of the plurality of pre-determined text domains corresponds to a respective text domain-specific machine learning model; and
selecting the text domain-specific machine learning model to use to determine the respective relevance score for each named entity of the one or more named entities based on the determined text domain to which the text belongs.

20. The one or more non-transitory computer-readable media of claim 15, wherein computer-executable instructions that, when executed, cause at least one processor to perform determining the one or more named entities based on the text further comprise computer-executable instructions that, when executed, cause at least one processor to perform determining a parent named entity, a sibling named entity, or a child named entity in the named entity taxonomy of a named entity of the one or more named entities.
